(19) United States
(12) Patent Application Publication
(10) Pub. No.: US 2026/0240183 A1
(43) Pub. Date: Aug. 20, 2026

(54) FUNCTIONAL CHEESE SAUCE

(71) Applicant: Cargill, Incorporated, Wayzata, MN (US)

(72) Inventors: Alexandra Raphaela CHRISTIANSEN, August, KS (US); Benjamin Robert MILLIS, Fridley, MN (US)

(73) Assignee: Cargill, Incorporated, Wayzata, MN (US)

(21) Appl. No.: 19/161,445

(22) PCT Filed: Mar. 7, 2024
(86) PCT No.: PCT/US2024/018801

§ 371 Date: Sep. 2, 2025

Related U.S. Application Data
(60) Provisional application No. 63/489,608, filed on Mar. 10, 2023.

(51) Int. Cl. A23C 19/09

(52) U.S. Cl. CPC A23C 19/0904

(57) ABSTRACT

The present disclosure provides a functional cheese sauce. The functional cheese sauce can be combined with various filling ingredients to form a self-supporting filling composition that can be pressed or shaped such that it is self-supporting at refrigeration temperatures or freezing temperatures. The filling composition maintain its shape and be suitable for use in automated high-throughput processing of a food product such as a wrap or burrito. Upon heating the filling composition, the self-supporting properties of the functional cheese sauce can disappear such that the filling composition falls apart into a food product with desirable organoleptic properties. Compositions of the functional cheese sauce, filling compositions, wrapped food products, and methods of the making are described.

### CROSS-REFERENCE TO RELATED APPLICATIONS

This application claims the benefit of U.S. Provisional Application No. 63/489,608, filed Mar. 10, 2023, which is incorporated by reference herein in its entirety.

### FIELD

The present disclosure relates to a functional cheese sauce and methods for its incorporation into food products. More specifically, the present disclosure relates to a functional cheese sauce that can be used to make filling compositions and food products such as wrapped food products including wraps, burritos, rollups, and the like, and methods of making such food products.

### BACKGROUND

Food products, such as wraps, burritos, and rollups typically include a soft, pliable flatbread wrapped or rolled around a filling composition. Prior methods of preparing wrapped food products include manually portioning and disposing various filling ingredients such as one or more of meats, beans, vegetables, egg, sausage, cooked rice, spices, and cheese, as well as sundry condiments onto a flatbread. Solid or semi-solid ingredients of the filling are usually provided in small pieces, such as chopped pieces, diced pieces, slices, chunks, carvings, grains, granules, shavings, sections, parings, mince, beans, and the like. The flavor, shape, texture, appearance, scent, and/or other qualities of filling ingredients are very important and contribute to a consumer's experience of the wrapped food product. Such prior methods for providing a filling composition for use in a wrapped food product can be relatively slow and/or labor-intensive and can be inconvenient for automation.

When creating a filling composition for a wrapped food product used in high throughput automated processing procedures and for storage at refrigeration or freezing temperatures, various limitations exist using current technologies that bind the ingredients together at refrigerated or freezing temperatures. Current technologies to bind ingredients during high-throughput processing and cold storage conditions can have negative impacts on lubricity during processing steps and can negatively affect the organoleptic properties of the products when eaten. Thus, a need exists for providing a way to overcome the limitations present in the prior methods and compositions.

### SUMMARY

The present disclosure relates to a functional cheese sauce, filling compositions containing the functional cheese sauce, and food products made with the filling compositions. The disclosure further provides methods for the preparation of the functional cheese sauce, the filling compositions, and the food products.

The functional cheese sauce compositions herein can be used to make food products such as wraps, burritos, rollups, and the like, all of which can be referred to herein as a “wrap,” a “food product,” or a “wrapped food product”. The food products can include a soft, pliable flatbread wrapped or rolled around a filling composition. The filling composition can include a variety of filling ingredients that are refrigerated or frozen until they are heated and/or consumed.

A functional cheese sauce has been discovered that effectively mixes with refrigerated or frozen filling ingredients and that acts as a binder to form a filling composition with the filling ingredients. The functional cheese sauce can impart self-supporting properties (e.g., binding properties and/or shape-holding properties) to the filling compositions at refrigeration temperatures or freezing temperatures. The functional cheese sauce further can impart self-supporting properties to the filling compositions during portioning or during high-throughput processing techniques, thereby creating a consistently sized and shaped portion that stays bound together during handling at refrigeration temperatures or freezing temperatures. The functional cheese sauce further can provide lubricity to the filling compositions at refrigeration temperatures or freezing temperatures so that they are more easily handled and/or so that they do not clog assembly line machinery during processing.

While the functional cheese sauce compositions herein impart self-supporting properties to a filling composition at refrigeration temperatures or freezing temperatures, the functional cheese also advantageously loses the ability to impart self-supporting properties to the filling composition upon heating due to the functional cheese sauce melting into the food product. By way of example, the filling ingredients mixed with the functional cheese sauce compositions herein can be disposed upon a surface of a flatbread and subsequently heated, whereupon the filling composition can collapse or change shape. The resulting heated food product can have a filling composition with pleasant organoleptic properties not influenced by the presence of the functional cheese sauce.

The filling compositions herein can include a functional cheese sauce and one or more filling ingredients. The functional cheese sauce can be sufficiently flowable that when it is combined with refrigerated or frozen filling ingredients, it can easily be mixed therewith to form the filling composition.

The present disclosure further provides a filling composition having self-supporting properties and containing the functional cheese sauce and filling ingredients in a pre-prepared mixed portion that can be frozen, stored, and shipped at refrigeration temperatures or freezing temperatures, and can also provide an organoleptically pleasing food product for consumers when heated.

Accordingly, the present disclosure provides a functional cheese sauce that can impart self-supporting properties including binding properties and shape-holding properties to one or more filling ingredients when combined to form a filling composition. The functional cheese sauce compositions herein further can be used to form a filling composition to be used as a component of a food product. The functional cheese sauce further is configured to lose its ability to impart self-supporting properties to the filling compositions such that the binding properties and shape-holding properties are also lost upon heating to food-safe temperatures of greater than 145° F. (~63° C.).

In an aspect, a method of preparing a food product is provided, where the method includes: a) providing a functional cheese sauce, where the functional cheese sauce is flowable; b) providing filling ingredients, wherein at least 50% of the filling ingredients have a longest dimension size of from 0.3 cm to 4.0 cm; c) mixing the functional cheese sauce with the filling ingredients to provide a filling composition, wherein the filling ingredients are at a temperature of about 20° F. to about 34° F. at the time of mixing; and d) forming the filling composition into a predetermined shape to provide a shaped filling composition that is self-supporting for at least two minutes at a refrigeration temperature of 40° F. and wherein the shaped filling composition is not self-supporting at an internal temperature of at least 145° F.

In a further aspect, a filling composition is provided that includes a functional cheese sauce, where the functional cheese sauce is flowable at a temperature of from 32° F. to 40° F.; and one or more filling ingredients mixed with the functional cheese sauce, wherein at least 50% of the filling ingredients have a longest dimension size of from 0.3 cm to 4 cm; and where the filling composition is self-supporting for at least two minutes at a refrigeration temperature of 40° F. and wherein the shaped filling composition is not self-supporting at an internal temperature of at least 145° F.

In a further aspect, a food product is provided that includes a flatbread; and a filling composition including a functional cheese sauce and one or more filling ingredients, wherein at least 50% of the one or more filling ingredients have a longest dimension size of from 0.3 cm to 4 cm; and where the filling composition is self-supporting for at least two minutes at a refrigeration temperature of 40° F. and wherein the shaped filling composition is not self-supporting at an internal temperature at a food-safe temperature of at least 145° F.

In a further aspect, a method of making a heated food product is provided, including the steps of a.) providing a filling composition; b.) positioning the filling composition upon a surface of a flatbread, where the flatbread can include a tortilla; c.) wrapping the filling composition within the flatbread to provide a wrapped food product; and d.) heating the wrapped food product.

This summary is an overview of the present disclosure and is not meant to be an exhaustive or exclusive of the description of the present subject matter. Additional details are found herein in the Detailed Description and appended Claim Set. Other aspects of the present disclosure will be apparent to those skilled in the art upon review of the disclosure and claims that follow.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Creating a food product using edible binder additives that impart binding properties onto the product can present many challenges. Various edible food binders can include, for example, various types of starches and/or proteins, modified carbohydrates such as celluloses, egg whites, and the like. Creating a food product that has binding properties that can be used for automated assembly lines at high throughputs further can present many challenges. In some instances, using food binders in a food product that is processed at high throughput speeds can fail to provide the food product with binding properties such that it can fall apart and can result in loss of the food product or inconsistent ingredient distribution. In some instances, filling ingredients using food binders can create friction along the high-throughput assembly line machinery thus causing additional problems when trying to portion such ingredients and can halt production. Further, while combinations of filling ingredients and such edible food binders can provide supportive properties, upon heating many do not decohere and remain in a rigid shape.

Creating a food product that uses edible binder additives that impart binding properties onto the food product can further present challenges with organoleptic properties in the food product. In unsuitable ratios, these binders can deleteriously affect the organoleptic properties of food products when eaten. For example, some filling compositions can be made using binder additives can have an undesirable slimy mouthfeel, while in others can impart undesirable bitter or astringent tastes or grainy textures to the filling composition. It has been discovered herein that a functional cheese sauce composition can act as a binder for filling ingredients or filling compositions to provide self-supporting properties to a filling composition at refrigeration temperatures and freezing temperatures. The filling ingredients or filling compositions further can then lose the self-supporting properties when heated such that the filling composition is no longer bound together and no longer holds a consistent shape. It has further been discovered that the functional cheese sauce compositions herein can provide lubricious properties to a food product or composition, and they do not lend undesirable organoleptic properties to food products when heated. It has yet further been discovered that the functional cheese sauce herein does not detract from desirable organoleptic properties, such as color, taste, aroma, and texture (e.g., no fouling of the aroma, no change in color, no change to a creamy flavor and mouthfeel, and no change to a cheese-like taste and texture).

### Definitions

As used herein, the term “refrigeration temperatures” refers to temperatures of from greater than 32° F. and up to 40° F. (i.e., greater than 0° C. up to 4.5° C.). It will be appreciated that as used herein, the term “refrigerated” further refers to those items subject to refrigeration temperatures.

As used herein, the term “freezing temperatures” refers to temperatures of from equal to or less than 32° F. (i.e., less than 0° C.). It will be appreciated that as used herein, the term “frozen” further refers to those items subject to freezing temperatures.

In the present disclosure, the functional cheese sauce compositions can be described as flowable. As used herein, the term “flowable” can be used to describe a functional cheese sauce that is able to flow under its own weight from a starting point to a stopping point at a given temperature for a given time period as measured by a Bostwick consistometer (described below).

As used herein, the term “self-supporting” refers to the properties that the functional cheese sauce can impart onto a filling composition, including binding properties and/or shape-holding properties, at refrigeration temperatures or at freezing temperatures. The binding properties and shape-holding properties can manifest from various physical properties such as cohesion and adhesion contributed by the functional cheese sauce. The functional cheese sauce is configured to impart self-supporting properties on the filling composition such that it is capable of preventing any slumping or other change of shape to the filling composition once it has been portioned such that the height, width, and length of the filling composition do not change by more than 5% relative to the starting shape at refrigeration temperatures.

As used herein, the term “processed cheese” refers to a food product made with the aid of heat and one or more cheeses of the same or two or more varieties as further defined in 21 C.F.R. § 133.169 and as modified on Jan. 6, 1993.

As used herein, the term “cheddar cheese” refers to a cheese made from one or more dairy ingredients and as further defined by 21 C.F.R. § 133.113 and as modified on Jan. 6, 1993. The cheddar cheese further can include ingredients such as coloring agents, calcium chloride, enzymes, and the like, consistent with the requirements of 21 C.F.R. § 133.113.

As used herein, the term “food product” can refer to foodstuffs such wraps, burritos, rollups, and the like that include a soft, pliable flatbread wrapped or rolled around a filling composition. The term food product as used herein can be inclusive of the terms “wrap” or “wrapped food product,” in the singular or the plural, where it will be appreciated that the terms can be used interchangeably herein.

As used herein, the term “flatbread” can refer to foodstuffs, including but not to be limited to, tortillas made from a flour such as wheat, maize, or sorghum; pita bread; naan bread; chapatti; injera; msemmen; and the like. Preferred are flatbreads that are soft and/or pliable, as they can be more suited for use in a wrapped food product.

As used herein, the noun “wrap” refers to a food made from a flatbread rolled, wrapped, or otherwise folded around a filling composition. An example of a wrap is a burrito. The term “wrap” can be used interchangeably herein with the terms “food product,” or a “wrapped food product” unless otherwise noted.

### Functional Cheese Sauce

A functional cheese sauce as described herein can be combined and/or mixed with filling ingredients to provide a filling composition as described elsewhere. The filling composition can be disposed on a flatbread and wrapped and/or rolled within the flatbread to provide a food product.

The functional cheese sauce can be made from one or more ingredients including, but not to be limited to, water; a processed cheese; a cheddar cheese; butter that is salted or unsalted; milk or milk products such as non-fat dry milk, whey, curd, milkfat, and the like; sodium chloride; one or more gums, such as xanthan gum, carrageenan, and the like; one or more alginates including sodium alginate, potassium alginate, calcium alginate, and the like; one or more starches isolated from waxy maize, tapioca, potato, or rice; one or more phosphates such as sodium phosphate, potassium phosphate, or calcium phosphate; or one or more additional seasonings, flavorings, or coloring agents including annatto, apocarotenal, and paprika.

The water present in the functional cheese sauces herein can include an amount of added water at from 30% to 70% by weight (wt. %). In various aspects, the functional cheese sauces herein can include added water in an amount of from 30 wt. % to 70 wt. %, or from 40 wt. % to 60 wt. %, or from 45 wt. % to 50 wt. %. It will be appreciated that the added water present in functional cheese sauces herein can include an amount of from 30 wt. %, 35 wt. %, 40 wt. %, 45 wt. %, 50 wt. %, 55 wt. %, 60 wt. %, 65 wt. %, or 70 wt. %, or from within a range of any of the forging weight percentages. It will be appreciated that adding water to the functional cheese sauce allows the sauce to be flowable at the refrigeration temperatures or freezing temperatures where the functional cheese sauce and filling ingredients are mixed together. It was found herein that insufficient amounts of water in the functional cheese sauce can lead to a sauce that is not flowable and results in a filling composition that cannot maintain a shape and that exhibits negative breakage in the filling ingredient particles.

The processed American cheese present in the functional cheese sauces herein can include an amount of processed American cheese at from 10% to 25% by weight (wt. %). In various aspects, the functional cheese sauces herein can include processed American cheese in an amount of from 10 wt. % to 25 wt. %, or from 12 wt. % to 22 wt. %, or from 16 wt. % to 21 wt. %. It will be appreciated that the processed American cheese present in functional cheese sauces herein can include an amount of from 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, or 25 wt. %, or from within a range of any of the forging weight percentages. The processed cheese can include one or more of a processed cheese, a processed cheese food product, or a process cheese spread, such as for example a processed American cheese or a processed American cheese spread, or any combination thereof. Processed cheese suitable for use herein is further defined by 21 C.F.R. § 133.169.

By way of example, the processed cheese suitable for use herein can include cultured milk, skim milk, cream, cheddar cheese, cheese culture, lemon juice concentrate, sodium phosphate, salt enzymes, and one or more coloring agents. Without wishing to be bound by any particular theory, it is believed that processed cheese having a higher protein content and higher fat content are superior for creating an emulsion in the functional cheese sauce, which is understood to lend the properties of cohesion and lubricity to the functional cheese sauce. Having a higher protein and higher fat content can be suitable for lending the self-supporting properties to the filling compositions when shaped and when subjected to high-throughput processing. A higher protein content can include processed cheese having a protein content of from 15 wt. % to 25 wt. %, or more specifically from 19 wt. % to 22 wt. %. A higher fat content can include a processed cheese having a fat content of from 25 wt. % to 35 wt. %, or more specifically from 28 wt. % to 33 wt. %.

Exemplary processed cheeses can include Bongards® Yellow American Cheese (Bongards Creameries, Chanhassen, MN, USA), Land O'Lakes® Process American Cheese, (Land O'Lakes®, Inc., Arden Hills, MN, USA), or Ornua Pasteurized Blended Aged White American Cheese (Ornua Ingredients North American, Hilbert, WI, USA), or any processed cheese possessing properties similar thereto.

The cheddar cheese present in the functional cheese sauces herein can include an amount of cheddar cheese at from 10% to 20% by weight (wt. %). In various aspects, the functional cheese sauces herein can include cheddar cheese in an amount of from 10 wt. % to 20 wt. %, or from 12 wt. % to 18 wt. %, or from 14 wt. % to 17 wt. %. It will be appreciated that the cheddar cheese present in functional cheese sauces herein can include an amount of from 10 wt. %, 11 wt. %, 12 wt. %, 13 wt. %, 14 wt. %, 15 wt. %, 16 wt. %, 17 wt. %, 18 wt. %, 19 wt. %, or 20 wt. %, or from within a range of any of the forging weight percentages. The cheddar cheese can include one or more of a white cheddar cheese, an extra sharp cheddar cheese, a sharp cheddar cheese, a mild cheddar cheese, a medium cheddar cheese, a mature cheddar cheese, a vintage cheddar cheese, and the like, or any combination thereof. The cheddar cheese can be made from sterilized and/or pasteurized milk and one or more enzymes. Cheddar cheese suitable for use herein is further defined by 21 C.F.R. § 133.113. In various aspects, the processed cheese and cheddar cheese suitable for use herein further can contain one or more flavorings, spices, or colorings.

It will be appreciated that while the exemplary functional cheese sauce described herein incorporates a cheddar cheese in its formulation, other cheeses with similar water content, hardness, mouthfeel, and other properties of cheddar cheese can also be used to create similar functional cheese sauces to those described herein. Cheeses similar to cheddar can include one or more varieties of gouda, muenster, Colby, Swiss, Brick cheese, Monterey jack cheese, Edam cheese, Gloucester cheese, Gruyere, or combinations thereof.

The ratio of processed cheese to cheddar cheese also contributes to providing cohesion and lubricity to the functional cheese sauce. Ratios are discussed in more detail below.

The butter present in the functional cheese sauces herein can include an amount of butter at from 5% to 12% by weight (wt. %). In various aspects, the functional cheese sauces herein can include butter in an amount of from 5 wt. % to 12 wt. %, or from 7 wt. % to 11 wt. %, or from 8 wt. % to 10 wt. %. It will be appreciated that the butter present in functional cheese sauces herein can include an amount of from 5 wt. %, 6 wt. %, 7 wt. %, 8 wt. %, 9 wt. %, 10 wt. %, 11 wt. %, or 12 wt. %, or from within a range of any of the forging weight percentages. The butter can include a salted butter or an unsalted butter, or any combination thereof.

The milk product present in the functional cheese sauces herein can include an amount of milk product at from 1% to 8% by weight (wt. %). In various aspects, the functional cheese sauces herein can include milk product in an amount of from 1 wt. % to 8 wt. %, or from 2 wt. % to 7 wt. %, or from 3 wt. % to 6 wt. %. It will be appreciated that the milk product present in functional cheese sauces herein can include an amount of from 1 wt. %, 2 wt. %, 3 wt. %, 4 wt. %, 5 wt. %, 6 wt. %, 7 wt. %, or 8 wt. %, or from within a range of any of the forging weight percentages. The milk product can include on or more of a milk, a non-fat dry milk, whey, curd, or milkfat, or any combination thereof.

The starch present in the functional cheese sauces herein can include an amount of starch at from 0.5% to 6% by weight (wt. %). In various aspects, the functional cheese sauces herein can include starch in an amount of from 0.5 wt. % to 6 wt. %, or from 1 wt. % to 5 wt. %, or from 1.5 wt. % to 3.5 wt. %. It will be appreciated that the starch present in functional cheese sauces herein can include an amount of from 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 5 wt. %, or 5 wt. %, or from within a range of any of the forging weight percentages. The starch can include one or more starches isolated from corn, waxy maize, potato, tapioca, or rice, and can include starches that are modified, functionalized, or non-functionalized, or any combination thereof. Exemplary starches can include HOMECRAFT® tapioca starch (Ingredion, Westchester, IL, USA); PenPlus® 2100 modified potato starch (Ingredion, Westchester, IL, USA) PenPlus® 47 modified potato starch (Ingredion, Westchester, IL, USA), NOVATION PRIMA® 600 waxy maize starch (Ingredion, Westchester, IL, USA), ThermFlo® modified waxy maize starch (Ingredion, Westchester, IL, USA), PermaFlo® modified waxy maize starch (Tate & Lyle, Hoffman Estates, IL, USA), or starches with similar properties thereto.

The phosphate present in the functional cheese sauces herein can include an amount of phosphate at from 0.1% to 5% by weight (wt. %). In various aspects, the functional cheese sauces herein can include phosphate in an amount of from 0.1 wt. % to 5 wt. %, or from 0.3 wt. % to 3 wt. %, or from 0.5 wt. % to 1.5 wt. %. It will be appreciated that the phosphate present in functional cheese sauces herein can include an amount of from 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 4 wt. %, or 5 wt. %, or from within a range of any of the forging weight percentages. The phosphate can include one or more phosphates such as sodium phosphate, potassium phosphate, or calcium phosphate, or any combination thereof.

The gum present in the functional cheese sauces herein can include an amount of gum at from 0.01% to 3% by weight (wt. %). In various aspects, the functional cheese sauces herein can include gum in an amount of from 0.01 wt. % to 3 wt. %, or from 0.03 wt. % to 1 wt. %, or from 0.05 wt. % to 0.5 wt. %. It will be appreciated that the gum present in functional cheese sauces herein can include an amount of from 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, or 3 wt. %, or from within a range of any of the forging weight percentages. The gum can include carrageenan, xanthan gum, guar gum, acacia gum, agar, arrowroot gum, locust bean gum, collagen, carrageenan gum, sodium alginate, alginic acid, gum arabic, gum ghatti, gum tragacanth, beta-glucan, karaya gum, dammar gum, glucomannan, tara gum, gellan gum, or any combination thereof.

The alginate present in the functional cheese sauces herein can include an amount of alginate at from 0.01% to 3% by weight (wt. %). In various aspects, the functional cheese sauces herein can include alginate in an amount of from 0.01 wt. % to 3 wt. %, or from 0.02 wt. % to 1 wt. %, or from 0.05 wt. % to 0.5 wt. %. It will be appreciated that the alginate present in functional cheese sauces herein can include an amount of from 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, or 3 wt. %, or from within a range of any of the forging weight percentages. The alginate can include sodium alginate, potassium alginate, calcium alginate, or any combination thereof.

The salt present in the functional cheese sauces herein can include an amount of salt at from 0.1% to 5% by weight (wt. %). In various aspects, the functional cheese sauces herein can include salt in an amount of from 0.1 wt. % to 5 wt. %, or from 0.2 wt. % to 3 wt. %, or from 0.3 wt. % to 1.5 wt. %. It will be appreciated that the salt present in functional cheese sauces herein can include an amount of from 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 4 wt. %, or 5 wt. %, or from within a range of any of the forging weight percentages. The salt can include sodium chloride

In an aspect, a functional cheese sauce is provided, where the functional cheese sauce includes water at from 30 wt. % to 70 wt. %, processed American cheese at from 10 wt. % to 25 wt. %, white cheddar cheese at from 10 wt. % to 20 wt. %, salted butter at from 5 wt. % to 12 wt. %, non-fat dry milk at from 1 wt. % to 8 wt. %, starch from waxy maize at from 0.5 wt. % to 6 wt. %, sodium phosphate at from 0.1 wt. % to 5 wt. %, xanthan gum at from 0.01 wt. % to 3 wt. %, sodium alginate at from 0.01 wt. % to 3 wt. %, and sodium chloride at from 0.1 wt. % to 5 wt. %.

In an aspect, a functional cheese sauce is provided, where the functional cheese sauce includes water at from 45 wt. % to 50 wt. %, processed American cheese at from 16 wt. % to 21 wt. %, white cheddar cheese at from 14 wt. % to 17 wt. %, salted butter at from 8 wt. % to 10 wt. %, non-fat dry milk at from 3 wt. % to 6 wt. %, starch from waxy maize at from 1.5 wt. % to 3.5 wt. %, sodium phosphate at from 0.5 wt. % to 1.5 wt. %, xanthan gum at from 0.05 wt. % to 0.5 wt. %, sodium alginate at from 0.05 wt. % to 0.5 wt. %, and sodium chloride at from 0.3 wt. % to 1.5 wt. %. An exemplary functional cheese sauce is summarized in Table 1.

TABLE 1
Exemplary Functional Cheese Sauce Formulation

| | Percentage of |
|---|---|
| Ingredient | Formulation (wt. %) |
| water | 45-50% |
| processed American | 16-21% |
| cheese | |
| white cheddar cheese | 14-17% |
| salted butter | 8-10% |
| non-fat dry milk | 3-6% |
| starch from waxy | 1.5-3.5% |
| maize | |
| sodium phosphate | 0.5-1.5% |
| xanthan gum | 0.05-0.5% |
| sodium alginate | 0.05-0.5% |
| sodium chloride | 0.3-1.5% |
| total | 100% |

It is an advantage of the functional cheese sauce herein that the phosphate, gum, starch, and an alginate can be used without negatively affecting the organoleptic properties of the filling composition and food products made therefrom. Such ingredients provided alone are not sufficient to bind the filling ingredients into a coherent filling composition, provide lubricity to high-throughput processing, and contribute to desirable organoleptic properties in a food product. As such, without wishing to be bound by any particular theory, it is believed that the phosphate, gum, starch, and an alginate can contribute to the self-supporting properties to the functional cheese sauce. In various aspects, the functional cheese sauce includes less than 3 wt. % any combination of one or more of xanthan gum, sodium alginate, phosphate salt, or starch. In various aspects, the functional cheese sauce includes less than 5 wt. % any combination of one or more of xanthan gum, sodium alginate, phosphate salt, or starch.

It will be appreciated that any of the phosphate, gum, starch, and an alginate are added to the filling compositions herein as part of the functional cheese sauce and not as single ingredients added directly to the filling compositions.

In the present disclosure, the functional cheese sauce compositions can be described as flowable. As stated above, the term “flowable” can be used to describe a functional cheese sauce that is able to flow under its own weight from a starting point to a stopping point at a given temperature for a given time period as measured by a Bostwick consistometer. The Bostwick consistometer can be used to determine a sample consistency that can be reported as a distance traveled at a given temperature in a given amount of time. The consistency of the functional cheese sauce can be measured by filling a gated reservoir section of a Bostwick consistometer with the functional cheese sauce, holding the temperature of the consistometer within a 2 OF range, releasing the gate of the reservoir section, and timing how long it takes the functional cheese sauce to travel a distance from a starting point to a stopping point within a given amount of time. The consistency can be measured using a Bostwick consistometer at any temperature so long as all measurements are taken at the same temperature for comparative purposes.

The functional cheese sauces herein are considered to be flowable when measured using a Bostwick consistometer when able to traverse a distance from a starting point to a stopping point of from 5 cm to 12 cm or from 5 cm to 10 cm, at any temperature of from about 155° F. to about 165° F. (e.g., about 68° C. to 74° C.) over 10 seconds. In various aspects, the functional cheese sauces herein can traverse a distance from a starting point to a stopping point of anywhere from 5 cm, 6 cm, 7 cm, 8 cm, 9 cm, 10 cm, 11 cm, or 12 cm, or a range of any of the forgoing, at a temperature of 155° F. to about 165° F. over 10 seconds. In an aspect, the functional cheese sauces herein are considered to be flowable when able to traverse a distance from a starting point to a stopping point of 8 cm at a temperature of 160° F. (e.g., about 71° C.) over 10 seconds.

In another aspect, the functional cheese sauce is considered to be flowable at a temperature of from 32° F. to 40° F. For example, the functional cheese sauce can be flowable when able to traverse a distance from a starting point to a stopping point of 1 cm to 5 cm at a temperature of 34° F. to 36° F. (about 1° C. to about 2° C.) over 10 seconds. In various aspects, the functional cheese sauces herein can traverse a distance from a starting point to a stopping point of anywhere from 1 cm, 2 cm, 3 cm, 4 cm, 5 cm, or 6 cm, or a range of any of the forgoing, at a temperature of 34° F. to 36° F. over 10 seconds. For example, the functional cheese sauce can traverse a distance from a starting point to a stopping point of about 0 cm to about 6 cm, or about 1 cm to about 6 cm, or about 1 cm to about 5 cm, or about 1 cm to about 4 cm, or about 2 cm to about 5 cm, or about 2 cm to about 7 cm over about 5 seconds to about 15 seconds, or about 7 seconds to about 13 seconds, or about 8 seconds to about 12 seconds, or about 10 seconds at a temperature of about 28° F. to about 40° F. (about −2° C. to about 4.4° C.), or about 30° F. to about 38° F. (about −1° C. to about 3.3° C.), or about 32° F. to about 37° F. (about 0° C. to about 2.8° C.), or about 34° F. to about 36° F. (about 1° C. to about 2° C.).

When performing a measurement using the Bostwick consistometer, the temperature is held within a 2° F. range about the desired temperature for performing the measurement. By way of example, when the desired temperature for performing the measurement is 160° F., the Bostwick consistometer is held at from 159° F. to about 161° F. over 10 seconds. In another example, when the desired temperature for performing the measurement is 35° F., the Bostwick consistometer is held at from 34° F. to about 36° F. over 10 seconds.

The functional cheese sauce can be flowable as defined herein at a temperature of about 26° F. to about 41° F. (about −3° C. to about 5° C.), or about 26° F. to about 39° F. (about −3° C. to about 4° C.), or about 26° F. to about 37° F. (about −3° C. to about 3° C.), or about 26° F. to about 36° F. (about −3° C. to about 2° C.), or about 27° F. to about 35° F. (about −3° C. to about 1.7° C.), or about 27° F. to about 34° F. (about −3° C. 1.1° C.° C.), or about 28° F. (about −2° C.).

In an aspect, the functional cheese sauce disclosed herein can flow sufficiently at refrigeration temperatures such that when mixed with filling ingredients, the functional cheese sauce binds the filling ingredients together to form a coherent filling composition. The functional cheese sauce can be tempered to a temperature of about 35° F. prior to mixing such that it is flowable and able to blend thoroughly with the filling ingredients. The filling ingredients can include one or more edible ingredients in the form of discrete pieces as described herein. In order to bind the filling ingredients, the functional cheese sauce can flow between and around any pieces and/or portions of the filling ingredients and act to bind the pieces and/or portions together to form a self-supporting filling composition. The filling ingredients can be mixed with the functional cheese sauce at refrigeration temperatures or freezing temperatures, and accordingly in a preferred aspect the functional cheese sauce flows sufficiently at the refrigeration temperatures or freezing temperatures and is sufficiently adhesive or cohesive that as a result the functional cheese sauce mixes with the filling ingredients and binds them together to form a filling composition.

In an aspect, the functional cheese sauce includes cheese and added water. In the present context, added water is water that is combined with the total cheese, including the cheddar cheese and processed cheese, and does not include water inherently present in the cheese. The weight ratio of total cheese to added water in the functional cheese sauce can be 1:3 to 1:1, or 1:2 to 1:1, or 1:1.5 to 1:1; or 0.5:1, or 1:1 to about 3:2 with respect to the functional cheese sauce. The weight ratio total cheese to added water in the functional cheese sauce can be 0.5:1, 1:1, 1:1.5, 1:2, 2:3, 3:4, or 3:2 with respect to the functional cheese sauce. In various aspects, the weight ratio total cheese to added water in the functional cheese sauce can be from 1:1.40 to 1:1.20 with respect to the functional cheese sauce. In an aspect, the weight ratio of total cheese to added water in the functional cheese sauce can be 1:1.35.

The ratio of processed cheese to cheddar cheese in the functional cheese sauce can affect the binding properties and lubricity of the functional cheese sauce. As such, the weight ratio of processed cheese to cheddar cheese in the functional cheese sauce can be from 1:3 to 1:1, or from 1:2 to 1:1, or from 2:1 to 3:4, or from 2:1 to 1:1, or from 3:2 to 1:1, or from 13:10 to 12:10. In an aspect, the weight ratio of the processed cheese to cheddar cheese in the functional cheese sauce can be from 1.22:1.

As noted hereinabove, the functional cheese sauce described herein can act to bind filling ingredients without the presence of additional binders within the filling composition. A further advantage of the functional cheese sauce is that upon heating it to a serving temperature, such as an internal temperature of greater than 145° F., the binding properties of the functional cheese sauce are reduced, and the filling composition can decohere, collapse, and no longer remain bound together, and can contribute to an organoleptically pleasing filling composition for a food product.

In an aspect, the functional cheese sauce can provide lubricity to the filling compositions and various surfaced of automated assembly line machinery at refrigeration temperatures or freezing temperatures so that the filling compositions are more easily handled and/or so that they do not fall apart and clog the assembly line machinery during processing. By way of example, on assembly lines, particularly automated assembly lines, this property is particularly advantageous, as it can prevent undesirable hindrance in conveyance of the filling compositions within an assembly line.

The present disclosure provides a method for forming the functional cheese sauces herein using various techniques for mixing and heating food ingredients. The functional cheese sauce can include added water, processed American cheese, white cheddar cheese, salted butter, non-fat dry milk, starch from waxy maize, sodium phosphate, xanthan gum, sodium alginate, and sodium chloride. The method can include creating a slurry by mixing together a determined amount of each of the added water, non-fat dry milk, starch from waxy maize, sodium phosphate, xanthan gum, sodium alginate, and sodium chloride to form a slurry. The method further can include heating the salted butter until melted and then adding the slurry to the melted butter while mixing and heating to approximately 110° F. The method further can include adding the processed American cheese and white cheddar cheese to the butter slurry mixture, and mixing and heating the cheese, butter, and slurry ingredients to approximately 185° F.

### Filling Ingredients

The filling ingredients suitable for use in the filling compositions herein can include one or more edible ingredients in the form of discrete pieces. The discrete pieces can be a form inherent to the foodstuff (e.g. grains of rice, seeds, nuts etc.) or can be divided into discrete pieces by means such as chopping, grinding, slicing, crushing, peeling, or any means of reducing the size of the foodstuff. The foodstuffs of the filling ingredients are not particularly limited. Filling ingredients can include foodstuffs such as cooked meats (such as ham, pork, beef steak, beef, chicken, fish, sausage, bacon, and the like, and combinations thereof); mushrooms; vegetables (such as asparagus, broccoli, beans, peppers, onions, potatoes, lettuce, cabbage, and the like, and combinations thereof); cooked grains and/or legumes (such as quinoa, beans, chick peas, lentils and pulses); seeds such as sesame seeds; whole, divided, or chopped nut such as peanut, cashew nut, Brazil nut; cheese (such as blue, cheddar, Colby, gouda, Monterey jack, Swiss, and the like); fruit such as tomato, grapes, apple, and any combination thereof; and cooked egg, cooked egg constituents (such as cooked egg yolk and/or cooked egg whites), or any combination thereof.

As stated above, at least a portion of the filling ingredients can be in the form of pieces or particles. In an aspect, at least 30% or at least 40% or at least 50% or at least 60% or at least 70% or at least 80% or at least 90% by weight of the filling ingredient pieces or particles have a longest dimension size of about 0.1 cm to about 10 cm, or about 0.1 cm to about 5 cm, or about 0.2 cm to about 5 cm, or about 0.3 cm to about 5 cm, or about 0.4 cm to about 5 cm, or about 0.01 cm to about 4 cm, or about 0.05 cm to about 54 cm, or about 0.1 cm to about 4 cm, or about 0.2 to about 4 cm, or about 0.3 cm to about 4 cm, or about 0.1 cm to about 3 cm, or about 0.1 cm to about 2 cm, or about 0.2 cm to about 5 cm, or about 0.2 cm to about 3 cm, or about 0.2 cm to about 2 cm, or about 0.3 cm to about 3 cm, or about 0.2 cm to about 2.5 cm, or about 0.2 cm to about 2 cm, or about 1 cm to about 4 cm, or about 1 cm to about 5 cm.

The filling ingredients are stored frozen until use, and upon mixing with the functional cheese sauce, the filling ingredients remain frozen at temperatures, including from 26° F. to 30° F., or from 26° F. to 28° F. during mixing.

In an aspect, the filling ingredients can include ingredients that are not in discrete pieces, such as salsa, pico de gallo, guacamole, crema, sour cream, one or more types of vegetable oil such as olive oil, honey, vinegar, lemon juice, yeast, citric acid, fruit juice, and any combination thereof.

### Filling Compositions

The functional cheese sauce and the filling ingredients as described herein can be combined and/or mixed to provide a filling composition. The filling ingredients and the functional cheese sauce can be mixed in any order to provide the filling composition. The mixing can be accomplished manually, with a mixing machine, or a combination thereof. The functional cheese sauce can be mixed together with the filling ingredients at refrigeration temperatures or freezing temperatures to create a filling composition. The functional cheese sauce can maintain binding between the filling ingredients within the filling composition at refrigeration temperatures or freezing temperatures. In an aspect, the functional cheese sauce can maintain binding between the filling ingredients within the filling composition at freezing temperatures, refrigeration temperatures, or both refrigeration temperatures and freezing temperatures. It will be appreciated that the refrigeration temperatures as defined herein include those temperatures of from greater than 32° F. and up to 40° F. (i.e., greater than 0° C. up to 4.5° C.). It will be appreciated that the freezing temperatures as defined herein includes those temperatures of from equal to or less than 32° F. (i.e., less than 0° C.).

In an aspect, the functional cheese sauce and the filling ingredients are mixed together at temperatures of from 27° F. to 30° F. In an aspect, the functional cheese sauce and the filling ingredients are mixed together at temperatures of from 27° F. to 30° F., where the filling ingredients and functional cheese sauce are all stored at freezing temperatures prior to mixing. The functional cheese sauce is tempered to a temperature of about 35° F. such that it is flowable and able to blend thoroughly with the filling ingredients. In an aspect, the mixing can be is performed when the filling ingredients are stored at a temperature of less than 35° F., or less than 34° F., or less than 33 OF, or less than 32° F., or less than 31° F., or less than 30° F., or less than 29° F., or less than 28° F. In various aspects, the filling ingredients can be stored at a temperature of about 14° F. to about 36° F., or about 17° F. to about 34° F., or about 19° F. to about 34° F., or about 20° F. to about 41° F., or about 20° F. to about 34° F., or about 25° F. to about 36° F., or about 25° F. to about 34° F., or about 27° F. to about 36° F., or about 26° F. to about 30° F., or about 28° F. It will be appreciated that the filling ingredients can be present at temperatures of from 24° F. up to 40° F. when mixed with the functional cheese sauce to form the filling compositions.

The filling composition can be shaped and/or compressed into a self-supporting coherent filling composition by the imposition of a force, such as by pressure, in order to enhance the binding properties of the functional cheese sauce. The pressing, compressing, and/or shaping can be accomplished manually or by machine. The filling composition can be shaped and/or pressed by hand or machine into a shape, for example a predetermined shape. The shape formed by compressing the filling composition is not particularly limited. For example, the filling composition can be shaped into an approximately cuboid or cube-shaped block for subsequent placement onto or within a flatbread such as a tortilla for making a burrito. In an aspect the filling composition can be pressed into an irregular shape by hand or by machine. The shaped filling composition is self-supporting as defined hereinabove. It will be appreciated that the filling composition can be pre-portioned into a serving that can be shaped as a patty, a cylinder, a cube, a cuboid, and the like.

A shaped filling composition can be self-supporting at refrigeration temperatures or freezing temperatures, or both. Such a self-supporting shaped filling composition can be conveniently portioned and handled for further processing, freezing, storage, transportation, and/or inclusion into a food product. By way of example, the filling composition can be disposed upon a surface of a flatbread and wrapped or rolled within the flatbread to provide a food product, such as a wrapped food product that can be refrigerated, frozen, and/or stored for future use.

In an aspect, the presence of the functional cheese sauce within the filling composition provides a robustness through the binding properties and the lubrication properties that it provides to the filling composition such that the filling ingredients are not able to break down by the force of processing, handling, conveying, and the like as compared to a filling composition that lacks the functional cheese sauce.

When the filling compositions herein are heated to food-safe temperatures of at least 145° F., the functional cheese sauce can melt or meld into the filling ingredients such that the functional cheese sauce no longer imparts the self-supporting properties to the filling composition (i.e., the functional cheese sauce no longer binds the filling ingredients together). As a result, the filling composition can collapse and/or otherwise decohere. The functional cheese sauce can meld into the heated food product to contribute to desirable organoleptic properties in the final product as compared to filling compositions lacking the functional cheese sauce. Accordingly, when heated at the point of sale, for example as a breakfast burrito, the consumer will not notice a difference in texture or taste using the functional cheese sauce compositions herein as compared to food products that do not incorporate the functional cheese sauce compositions.

It will be appreciated that the functional cheese sauce may begin to lose the ability to impart self-supporting properties to a filling composition at temperatures above 40° F. for a time period of more than 1 minute or more than 2 minutes as the functional cheese sauce transitions from refrigeration temperatures or freezing temperatures. It will further be appreciated that the functional cheese sauce may being to lose the ability to impart self-supporting properties to a filling composition when heated above 40° F. By way of example, when the filling composition has an internal temperature of above 40° F. to 150° F., or 80° F. to 140° F., or 100° F. to 145° F., the functional cheese sauce is no longer self-supporting as defined elsewhere herein. However, it will be appreciated from a food safety perspective, heating to food-safe temperatures of above 145° F. is preferred for the safety and satisfaction of the consumer.

It was surprisingly found herein that the functional cheese sauce a self-supporting property to the filling compositions at refrigeration temperatures or freezing temperatures, but upon heating the self-supporting properties ceased to exist. Accordingly, upon heating a food product containing the functional cheese sauce, the filling composition can collapse and/or decohere, thereby providing a food product with pleasing organoleptic properties and satisfying customer expectations.

In an aspect, the filling ingredients can make up a large proportion or even the majority of the filling composition. The filling composition can include from 40 to 98 percent by weight (wt. % or w/w %) of the filling ingredients (i.e., the weight of the filling ingredients divided by the total weight of the filling composition including the filling ingredients and then multiplied by 100). The filling composition can include from 40 wt. % to 98 wt. %, or from 50 wt. % to 98 wt. %, or from 60 wt. % to 98 wt. %, or from 70 wt. % to 98 wt. %, or from 80 wt. % to 98 wt. %, or from 85 wt. % to 98 wt. %, or from 60 wt. % to 80 wt. %, or from 50 wt. % to 80 wt. % of the filling ingredients. The filling ingredients can include a large proportion of food pieces that must be bound in order to achieve the advantages of the functional cheese sauce. Accordingly, the binding properties of the functional cheese sauce must be particularly effective when the filling ingredients make up a large proportion of the filling composition, because there is less functional cheese sauce to bind a given amount of the filling ingredients. The functional cheese sauce can become ineffective at binding the filling ingredients in the filling composition when the filling composition includes less than 3 wt. % of the functional cheese sauce with respect to the weight of the filling composition or less than 3.1 wt. % with respect to the filling ingredients.

In an aspect, the filling composition can include 3 wt. % to 50 wt. % of the functional cheese sauce, or 3 wt. % to 40 wt. %, or 3 wt. % to 30 wt. %, or 3 wt. % to 20 wt. %, or 5 wt. % to 50 wt. %, or 5 wt. % to 40 wt. %, or 5 wt. % to 30 wt. %, or 5 wt. % to 20 wt. %, or 5 wt. % to 10 wt. %, or 10 wt. % to 50 wt. %, or 10 wt. % to 40 wt. %, or 10 wt. % to 30 wt. %, or 10 wt. % to 20 wt. %, or 20 wt. % to 50 wt. %, or 30 wt. % to 50 wt. %, or 40 wt. % to 50 wt. %, or 20 wt. % to 40 wt. % of the functional cheese sauce with respect to the weight of the filling composition.

As noted hereinabove, the functional cheese sauce described herein can act as a binder for filling ingredients without additional binders being added to the filling composition. Accordingly, in various aspects, the filling composition as described herein can include less than 5 wt. % or less than 4 wt. % or less than 3 wt. % or less than 2 wt. % or less than 1 wt. % of protein-based binding agents such as egg, egg white, soy protein, or whey protein. In various aspects, the functional cheese sauces herein do not contain any additional binders.

After shaping, the filling composition is self-supporting as defined herein for at least one minute, or at least two minutes, or at least three minutes, or at least four minutes, or at least five minutes, or at least six minutes, or at least 10 minutes, or at least 20 minutes at about 35° F., or about 34.5° F. to about 36° F., or about 32° F. to about 36° F. The above specified ranges of temperature and specific temperatures specify a minimum range of temperatures or a temperature over which the filling composition is self-supporting. However, the filling can be self-supporting outside of these ranges also. Accordingly, the self-support of the filling composition allows the filling composition to maintain shape, composition, and and/or mass for a period of time at the specified temperatures before the next step in the assembly of a food product, such as when creating a wrapped food product. This is an advantage for manual assembly of the food product and particularly advantageous for automated assembly of a wrapped food product, because it provides ease of handling and processing with commensurate benefits such as productivity and consistency of product (e.g. product portion size, taste, and other organoleptic properties). Consistency of product can aid in end consumer satisfaction because the product consistently meets customer expectations in regard thereto.

The filling composition itself can be a ready-to-eat or ready-to-heat food product without the addition of further components. However, the filling composition can be positioned on and wrapped in a flatbread alone or with other ingredients to provide a wrapped food product. The wrapped food product can be assembled by hand or by automation, refrigerated and/or frozen, and shipped refrigerated or frozen to a point-of-sale where a simple heating step can provide a heated wrapped food product for serving to a customer, when the favorable organoleptic properties of the wrap and the filling composition can be realized.

Accordingly, the filling compositions herein can be formed into pre-portioned servings that can be immediately frozen or can be distributed onto a surface of a flatbread for forming a food product, such as a wrapped food product. In an aspect, a method of preparing a formed, ready-to-heat or ready-to-eat food product can include: a) providing any one of the functional cheese sauces described herein, wherein the functional cheese sauce is flowable; b) providing any of the filling ingredients as described herein; c) combining and/or mixing the functional cheese sauce with the filling ingredients to provide any one of the filling compositions described herein; and d) forming the filling composition into a shape to provide a shaped filling composition that is self-supporting for at refrigeration temperatures or freezing temperatures; and wherein the shaped filling composition is not self-supporting at an internal temperature of at least 145° F. (50° C.).

International Patent Application Publication WO 2022/087105 A1 (which is incorporated by reference herein in its entirety) describes an automated burrito maker. A filling composition can be shaped into discrete patties or blocks can be used as a filling of a burrito or a part of the filling of a burrito. The process can be accomplished in a number of ways, such as feeding loose ingredients and functional cheese sauce into a hopper or other input device, portioning the mixture into measured doses, and compressing the doses to form a solid or semi-solid patty or block. The functional cheese sauces and filling compositions described in the present application can be used in the automated burrito making processes and automated burrito maker as described in International Patent Application Publication WO 2022/087105 A1, which is incorporated herein in its entirety and for all purposes.

### Food Products

Various food products are contemplated herein that include the functional cheese sauces and filling compositions as described. The food products herein can include any type of wraps, burritos, and rollups that typically include a soft, pliable flatbread wrapped or rolled around a filling composition. In an aspect, a food product includes a flatbread and any of the filling compositions described herein. In an aspect, the food product includes a flatbread and the filling composition, wherein the flatbread is rolled or wrapped about the filling composition to form a wrapped food product. In various aspects, the food products herein can be considered to be ready-to-eat or ready-to-heat.

The food products can be formed using a pre-portioned filling composition. The filling composition can be formed using frozen or partially frozen filling ingredients and stored for future use as discussed elsewhere herein. The assembled food products can be refrigerated and/or frozen for transportation to a point-of-sale location, for example a fast-food restaurant, where the food product can be further stored frozen or refrigerated until heated for consumption by a customer.

In an aspect, the filling composition can be disposed upon a surface of a flatbread, and the flatbread and filling composition to form a food product that can be refrigerated or frozen prior to use. In an aspect, the food product can be heated together to an internal temperature of the filling composition of 145° F. to 195° F., or as described elsewhere herein to maintain food safety for the consumer.

### EXAMPLES

Various aspects of the present disclosure can be better understood by reference to the following Examples, which are offered by way of illustration. The present disclosure is not limited to the Examples given herein.

### Example 1: Comparative Example: Analysis of Various Starch Compositions for Binding Properties in a Breakfast Burrito Filling

In this example, various starch-based binder ingredients were analyzed for their ability to bind various filling ingredients to form a breakfast burrito composition. The starch ingredients used in this example are listed in Table 2.

TABLE 2
Various Starches used For Analyzing Binding Properties

| Starch Name | Vendor | Starch Source | Starch Properties |
|---|---|---|---|
| HOMECRAFT ® | Ingredion, | tapioca starch | Low hot temp |
| | Westchester, | | viscosity & soft gel |
| | IL, USA | | upon cooling. |
| PenPlus ® 2100 | Ingredion, | modified potato | Pregelatinized, very |
| | Westchester, | starch | high viscosity and |
| | IL, USA | | water holding |
| | | | capability. Freeze/ |
| | | | Thaw Stability |
| PenPlus ® 47 | Ingredion, | modified potato | Low pH stable, short |
| | Westchester, | starch | body. Excellent water |
| | IL, USA | | holding capability, |
| | | | medium viscosity. |
| NOVATION | Ingredion, | waxy maize | Native Starch, freeze/ |
| PRIMA ® 600 | Westchester, | starch | thaw stability, |
| | IL, USA | | tolerance to low temp |
| | | | storage. |
| ThermFlo ® | Ingredion, | modified food | Tolerance to Heat and |
| | Westchester, | starch from | Shear |
| | IL, USA | waxy maize | |
| PermaFlo ® | Tate & Lyle, | modified food | Thickening |
| | Hoffman | starch from | |
| | Estates, IL, | waxy maize | |
| | USA | | |

The filling ingredients used in the breakfast burrito composition analyzed in this example included a mixture of scrambled eggs, sausage, onion, and red peppers. The filling ingredients were slacked to 29° F. or 32° F. and mixed with each of the starch ingredients according to the formulations for each trial condition outlined in Table 3.

TABLE 3
Trial Conditions for Analyzing Various Starches on Binding Properties

| | Control | Trial 1 | Trial 2 | Trial 3 | Trial 4 | Trial 5 |
|---|---|---|---|---|---|---|
| Temp. (° F.) | 29° F. | 29° F. | 29° F. | 29° F. | 29° F. | 32° F. |
| Filling | 100% | 93.42% | 93.42% | 93.42% | 98.89% | 98.89% |
| (wt. %) | | | | | | |
| HOMECRAFT ® | — | 2.86% | — | — | 1.11% | — |
| (wt. %) | | | | | | |
| PenPlus ® 2100 | — | — | 2.86% | — | — | — |
| (wt. %) | | | | | | |
| Penplus 47 | — | — | — | 2.86% | — | 1.11% |
| Starch (wt. %) | | | | | | |
| water | — | 3.72% | 3.72% | 3.72% | 0.00% | 0.00% |
| (wt. %) | | | | | | |
| total | 100% | 100% | 100% | 100% | 100% | 100% |
| (wt. %) | | | | | | |

As used herein, the terms “slacked” or “slacking” refer to the process of moderating the temperature of a food to allow the food to gradually increase from a temperature of less than 21° F. to any temperature within a range of from 22° F. to 40° F. Slacking can be safely done by moving frozen food to a refrigerator under 40° F. to allow it to come up to a desired temperature slowly and safely before cooking.

Each of the modified and native starches were blended at a ratio of 1:1.3 ratio water to starch and mixed with the filling composition at 29° F. or 32° F. at <7 wt. % of starch binder and as indicated in Table 3. The starch-filling ingredient mixtures were pressed into a ⅛^{th} sheet pan (measuring approximately 6.5 inches by 9 inches). The mixtures were placed in blast freezer set to −35° F. for 10-15 minutes. The breakfast burrito compositions were removed from the blast freezer, released from the pans, and partitioned using a chef's knife to analyze the binding properties of the various starches during handling and portioning.

Results indicate that the mixtures for Trials 1 to 5 did not include enough moisture and the vegetables further did not release any additional moisture during the trial. As a result, many of these combinations were fragile at refrigeration temperatures and freezing temperatures where they did not hold together during transport to a flatbread wrap for rolling into a food product.

The HOMECRAFT® mixture blended well at 32° F. and held together slightly better than the HOMECRAFTR mixture blended at 29° F. Further observations indicate that the egg curds started to soften somewhat as temperatures increased, however, the vegetables remained solid and did not release additional moisture. While the direct addition of the starches yielded a breakfast burrito composition that allowed for portioning with limited breakage, each of the starches used contributed undesirable organoleptic properties to the breakfast burrito composition. For example, none of the starches melted into the remaining ingredients when heated and were detectable as undesirable organoleptic properties with respect to both taste and texture upon consumption.

### Example 2: Analysis of Various Cheese Sauce Compositions for Binding Properties in a Breakfast Burrito Filling

In this example, various functional cheese sauce compositions were analyzed for their ability to bind filling ingredients to form a breakfast burrito composition and for their ability to contribute to desirable organoleptic properties in the breakfast burrito composition. A variety of processed cheeses were analyzed, including Bongards® Yellow American Cheese (Bongards Creameries, Chanhassen, MN, USA), Land O'Lakes® Process American Cheese, (Land O'Lakes®, Inc., Arden Hills, MN, USA), Ornua Pasteurized Blended Aged White American Cheese (Ornua Ingredients North American, Hilbert, WI, USA), Glanbia Better Melt Cheddar (Glanbia Nutritionals, Fitchburg, WI, USA), and Kraft® Pasteurized Process American Cheese spread (Kraft Heinz, Co., Chicago, IL, USA). The functional cheese sauce compositions analyzed in this example are listed in Table 4.

TABLE 4
Functional Cheese Sauce Compositions

| | | | | | | | | | | Cheese |
|---|---|---|---|---|---|---|---|---|---|---|
| Ingredients | | Cheese | Cheese | Cheese | Cheese | Cheese | Cheese | Cheese | Cheese | Sauce |
| (wt. %) | Control | Sauce 1 | Sauce 2 | Sauce 3 | Sauce 5 | Sauce 6 | Sauce 7 | Sauce 8 | Sauce 9 | 12 |
| water | 33% | 47% | 47% | 47% | 47% | 47% | 47% | 47% | 47% | 47% |
| butter, salted | 8.9% | 8.9% | 8.9% | 8.9% | 8.9% | 8.9% | 8.9% | 8.9% | 8.9% | 8.9% |
| non-fat dry milk | 4.8% | 4.8% | 4.8% | 4.8% | 4.8% | 4.8% | 4.8% | 4.8% | 4.8% | 4.8% |
| NOVATION | 2.5% | 2.5% | 2.5% | 2.5% | 2.5% | — | — | — | 2.5% | 2.5% |
| PRIMA ® 600 | | | | | | | | | | |
| starch from waxy | | | | | | | | | | |
| maize | | | | | | | | | | |
| ThermFlo ® | — | — | — | — | — | 2.5% | 2.5% | 2.5% | — | — |
| modified starch | | | | | | | | | | |
| from waxy maize | | | | | | | | | | |
| salt | 0.45% | 0.45% | 0.45% | 0.45% | 0.45% | 0.45% | 0.45% | 0.45% | 0.45% | 0.45% |
| starter distillate | 0.12% | — | — | — | — | — | — | — | — | — |
| sodium phosphate | 0.8% | 0.8% | 0.8% | 0.8% | 0.8% | 0.8% | 0.8% | 0.8% | 0.8% | 0.8% |
| coloring agent(s) | 0.04% | 0.04% | 0.04% | — | 0.04% | 0.04% | 0.04% | 0.04% | — | — |
| xanthan gum | 0.05% | 0.05% | 0.05% | 0.05% | 0.05% | 0.05% | 0.05% | 0.05% | 0.05% | 0.05% |
| sodium alginate | 0.15% | 0.15% | 0.15% | 0.15% | 0.15% | 0.15% | 0.15% | 0.15% | 0.15% | 0.15% |
| American cheese | 2.0% | 2.0% | 2.0% | 2.0% | 2.0% | 2.0% | 2.0% | — | — | — |
| flavoring | | | | | | | | | | |
| white cheddar | 16% | 16% | 16% | — | 16% | 16% | 16% | 16% | 16% | 16% |
| cheese | | | | | | | | | | |
| Glanbia better | 17% | — | — | — | — | — | 17% | — | — | — |
| melt cheddar | | | | | | | | | | |
| process cheese | | | | | | | | | | |
| Land O'Lakes | — | 17% | — | — | — | 17% | — | 19% | 19% | — |
| Process American | | | | | | | | | | |
| Cheese | | | | | | | | | | |
| Kraft ® Pasteurized | — | — | 17% | — | 17% | — | — | — | — | — |
| Process American | | | | | | | | | | |
| Cheese Spread | | | | | | | | | | |
| Ornua ® | — | — | — | 33% | — | — | — | — | — | — |
| Pasteurized | | | | | | | | | | |
| Blended Aged | | | | | | | | | | |
| White Process | | | | | | | | | | |
| American Cheese | | | | | | | | | | |
| Bongards ® | — | — | — | — | — | — | — | — | — | 19% |
| Yellow American | | | | | | | | | | |
| Process Cheese | | | | | | | | | | |
| Bostwick | — | 9 cm, | 8 cm, | — | 8 cm, | 9 cm, | 6.5 cm, | 8 cm, | — | 11 cm, |
| Consistency | | 145° F., | 145° F., | | 145° F., | 165° F., | 160° F., | 160° F., | | 145° F., |
| | | 10 sec. | 10 sec. | | 10 sec. | 10 sec. | 10 sec. | 10 sec. | | 10 sec. |
| | | | | | | | | | | and 3.5 |
| | | | | | | | | | | cm; |
| | | | | | | | | | | 39° F., 10 |
| | | | | | | | | | | sec. |
| | | | | | | | | | | (post |
| | | | | | | | | | | freeze/ |
| | | | | | | | | | | thaw) |

The cheese sauces were mixed and cooked and frozen until use. Each cheese sauce was mixed with filling ingredients (e.g., scrambled eggs, sausage, onion, and red peppers) in a blending ratio of 9:1 cheese sauce to filling ingredients to form a breakfast burrito composition. The breakfast burrito compositions were pressed into a ⅛th sheet pan (measuring approximately 6.5 inches by 9 inches) and frozen in a blast freezer set to −35° F. for 10-15 minutes. The breakfast burrito compositions were removed from the blast freezer, released from the pans, and partitioned using a chef's knife.

The shaped breakfast burrito compositions with each of the functional cheese sauces tested were analyzed for their ability to maintain a shape and for their ability to minimize loss when handled. The shaped portions of the breakfast burrito compositions were placed on a flatbread and rolled along with the addition of an exterior paper wrapper. This wrapped food products were microwaved to 145° F. and were subject to taste testing and analyzed for their ability to hold or release a shape. Results are tabulated in Table 5.

TABLE 5
Binding Properties of Various Functional
Cheese Sauce Compositions

| Cheese | |
|---|---|
| Sauce | Observations |
| 1 | Capable of binding the filling ingredients. Undesirable |
| | organoleptic properties. |
| 2 | Binding was compromised, exhibiting fracturing of the filling |
| | ingredient particles upon cutting. Undesirable flavor impact. |
| 3 | Formulation was too dry and did not disperse throughout the |
| | filling ingredients enough to impart binding properties. |
| 5 | Formulation was too dry and did not disperse throughout the |
| | filling ingredients enough to impart binding properties. |
| 6 | Binding properties were suboptimal, exhibiting crumbling and |
| | fracturing upon shaping. |
| 7 | Exhibited prolonged melting properties and undesirable flavor |
| | impact. |
| 8 | Exhibited favorable flowability, enhanced binding, and desirable |
| | organoleptic properties. |
| 9 | — |
| 12 | Exhibited favorable flowability, enhanced binding, and desirable |
| | organoleptic properties. |

Cheese sauce 1 contributed to optimal binding properties for the breakfast burrito composition but had undesirable effects on the flavor. Cheese sauce 2 did not maintain binding properties for the breakfast burrito composition during portioning and handling and had undesirable effects on the flavor. Cheese sauces 3 and 5 were too dry and uncapable of dispersing throughout the filling ingredients to impart any significant binding properties on the filling ingredients. Cheese sauce 6 exhibited suboptimal binding properties and was unable to maintain a shape. Cheese sauce 7 exhibited prolonged melting during mixing, taking over 20 minutes to melt to create the cheese sauce and had an undesirable impact on the flavor profile. Cheese sauce 8 exhibited optimal flowability as described herein and was able to maintain a shape in the filling composition. When heated as a component of the filling composition, cheese sauce 8 melted into the ingredients as observed when the filling composition fell apart as if it had been portioned using a spoonful of filling into a flatbread and the organoleptic properties were excellent and desirable. Cheese sauce 12 exhibited properties similar to cheese sauce 8. Both cheese sauce 8 and cheese sauce 12 provided the filling composition with enhanced self-supporting properties and contributed to desirable organoleptic properties when heated to food-safe temperatures. It will be appreciated that cheese sauce 8 and cheese sauce 12 resulted in a final filling composition that was indistinguishable as a frozen product and was similar to a filling composition that had been spooned onto a flatbread by hand using a measured scoop.

Processes and compositions as described herein provide particular benefits. In an aspect, by providing a functional cheese sauce that is flowable and yet adhesive at refrigeration temperatures or freezing temperatures. The functional cheese sauce can adequately mix with filling ingredients and provide sufficient binding function for the filling ingredients to impart self-supporting properties to the filling composition until it is heated. Such a filling composition can be reproducible and well-defined with regard to quantity and shape. The filling composition can easily be conveyed in an automated or manual process without premature separation of filling ingredients. The filling composition can be quickly disposed upon a surface of a flatbread and assembled into a consistent wrapped food product. If the wrapped food product is not to be used immediately, it can be frozen for subsequent storage and/or transport to another location such as a point of sale, such as a fast-food restaurant, a convenience store, and the like.

The benefits of the functional cheese sauce and filling compositions described herein include enhanced productivity, increased product consistency, ability to mass-produce the filling compositions and/or wrapped food products either off-site, and a finished wrap or other food product that contains a functional cheese sauce that does not impart undesired organoleptic food properties to the final product.

It should be understood that the definitions described herein apply to all aspects as described unless otherwise stated.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference is to be considered supplementary to that of this document; for irreconcilable inconsistencies, the usage in this document controls.

Values expressed in a range format are to be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” is to be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis (w/w %) is used interchangeably with weight percent (wt. %) or percent by weight (% wt.) herein.

1. A method of preparing a food product, comprising:
a. providing a functional cheese sauce, wherein the functional cheese sauce is flowable;
b. providing filling ingredients, wherein at least 50% by weight of the filling ingredients have a longest dimension size of from 0.3 cm to 4 cm;
c. mixing the functional cheese sauce with the filling ingredients to provide a filling composition comprising 70 wt % to 98 wt % of the filling ingredients; and
d. forming the filling composition into a predetermined shape to provide a shaped filling composition that is self-supporting for at least two minutes at a refrigeration temperature of 40° F. and wherein the shaped filling composition is not self-supporting at an internal temperature at a food-safe temperature of at least 145° F.

2. (canceled)

3. The method of claim 1, wherein the functional cheese sauce is flowable when able to traverse a distance from a starting point to a stopping point of from 5 cm to 10 cm at a temperature of from 159° F. to about 161° F. over 10 seconds.

4. The method of claim 1, wherein the functional cheese sauce is flowable when able to traverse a distance from a starting point to a stopping point of 2 cm to 7 cm at a temperature of 34° F. to 36° F. over 10 seconds.

5. The method of claim 1, wherein the functional cheese comprises processed cheese and cheddar cheese.

6. (canceled)

7. The method of claim 1, wherein the functional cheese sauce further comprises one or more of butter, non-fat dry milk, or salt.

8. The method of claim 1, wherein the functional cheese sauce further comprises one or more of xanthan gum, sodium alginate, phosphate salt, or starch, and wherein the functional cheese sauce comprises less than 5 wt. % any combination of one or more of xanthan gum, sodium alginate, phosphate salt, or starch.

9. (canceled)

10. The method of claim 1, wherein the filling ingredients comprise one or more of egg, sausage, meat, beans, or vegetable.

11. The method of claim 1, the method further comprising freezing the shaped filling composition.

12. The method of claim 1, the method further comprising positioning the shaped filling composition on a surface of a flatbread to create a wrapped food product.

13. (canceled)

14. (canceled)

15. (canceled)

16. A filling composition comprising:
a functional cheese sauce, wherein the functional cheese sauce is flowable; and
70 wt % to 98 wt % of one or more filling ingredients mixed with the functional cheese sauce;
wherein at least 50% by weight of the filling ingredients have a longest dimension size of from 0.3 cm to 4 cm; and
wherein the filling composition is self-supporting for at least two minutes at a refrigeration temperature of 40° F. and wherein the shaped filling composition is not self-supporting at an internal temperature at a food-safe temperature of at least 145° F.

17. (canceled)

18. The filling composition of claim 16, wherein the functional cheese sauce is flowable when able to traverse a distance from a starting point to a stopping point of from 5 cm to 10 cm at a temperature of from 159° F. to about 161° F. over 10 seconds.

19. The filling composition of claim 16, wherein the functional cheese sauce is flowable when able to traverse a distance from a starting point to a stopping point of 2 cm to 7 cm at a temperature of 34° F. to 36° F. over 10 seconds.

20. The filling composition of claim 16, wherein the functional cheese comprises processed cheese and cheddar cheese.

21. (canceled)

22. The filling composition of claim 16, wherein the functional cheese sauce further comprises one or more of butter, non-fat dry milk, or salt.

23. The filling composition of claim 16, wherein the functional cheese sauce further comprises one or more of xanthan gum, sodium alginate, phosphate salt, or starch, and wherein the functional cheese sauce comprises less than 5 wt. % any combination of one or more of xanthan gum, sodium alginate, phosphate salt, or starch.

24. (canceled)

25. The filling composition of claim 16, wherein the filling ingredients comprise one or more of egg, sausage, meat, beans, or vegetable.

26. A food product comprising a flatbread and the filling composition of claim 16.

27. A functional cheese sauce comprising:
a processed cheese at from 10 wt. % to 25 wt. %;
a cheddar cheese at from 10 wt. % to 20 wt. %;
added water at from 30 wt. % to 70 wt. %;
salted butter at from 5 wt. % to 12 wt. %;
non-fat dry milk at from 1 wt. % to 8 wt. %;
starch from waxy maize at from 0.5 wt. % to 6 wt. %;
sodium phosphate at from 0.1 wt. % to 5 wt. %;
xanthan gum at from 0.01 wt. % to 3 wt. %;
sodium alginate at from 0.01 wt. % to 3 wt. %; and
sodium chloride at from 0.1 wt. % to 5 wt. %.

28. The functional cheese sauce of claim 27, wherein the processed cheese is at from 16 wt. % to 21 wt. %; the cheddar cheese is at from 14 wt. % to 17 wt. %; the added water is at from 45 wt. % to 50 wt. %; the salted butter is at from 8 wt. % to 10 wt. %; the non-fat dry milk is at from 3 wt. % to 6 wt. %; the starch from waxy maize is at from 1.5 wt. % to 3.5 wt. %; the sodium phosphate at from 0.5 wt. % to 1.5 wt. %; the xanthan gum at from 0.05 wt. % to 0.5 wt. %, the sodium alginate is at from 0.05 wt. % to 0.5 wt. %, and the sodium chloride is at from 0.3 wt. % to 1.5 wt. %, and wherein the functional cheese sauce comprises less than 5 wt. % of any combination of one or more of xanthan gum, sodium alginate, phosphate salt, or starch.

29. (canceled)

30. (canceled)

31. (canceled)

32. (canceled)

33. (canceled)

34. The food product of claim 25, wherein the flatbread is selected from a tortilla, pita bread, naan bread, chapatti, injera, or msemmen.

35. (canceled)

36. (canceled)
